(19) United States
(12) Patent Application Publication
(10) Pub. No.: US 2008/0100541 A1
(43) Pub. Date: May 1, 2008

(54) Organic light emitting diode pixel circuit

(75) Inventor: Jiunn-Yau Huang, Sinshih Township (TW)

Correspondence Address: RABIN & Berdo, PC, 1101 14TH STREET, NW, SUITE 500, WASHINGTON, DC, 20005, US

(73) Assignee: HIMAX TECHNOLOGIES LIMITED, Tainan County (TW)

(21) Appl. No.: 11/979,300

(22) Filed: Nov. 1, 2007

(30) Foreign Application Priority Data
Nov. 1, 2006 (TW) 095140485

(51) Int. Cl. G09G 3/14

(52) U.S. Cl. 345/76

(57) ABSTRACT

An organic light emitting diode (OLED) pixel circuit includes a first switch, a second switch, an energy storage element and an OLED. The first switch is controlled by a scan signal to transmit a data signal or not. The second switch provides a current to turn on the OLED. The energy storage element keeps a cross voltage between a gate and a source of the second switch and corresponding to the data signal so as to control the current generated by the second switch and thus to control a luminance of the OLED.

This application claims the benefit of Taiwan application Serial No. 95140485, filed Nov. 1, 2006, the subject matter of which is incorporated herein by reference.

### BACKGROUND OF THE INVENTION

1. Field of the Invention

The invention relates in general to an organic light emitting diode (OLED) pixel, circuit and more particularly to an OLED pixel circuit including two transistor switches and one capacitor.

2. Description of the Related Art

Recently, the technology for controlling an OLED pixel using two transistor switches and one capacitor has been fully developed, and the associated circuit designs also have been proposed. However, those circuit designs still have some drawbacks.

FIG. 1 (Prior Art) shows a conventional OLED pixel circuit. Agate of a switch 103 receives a scan signal SC1 to control whether to transmit a data signal DT1 to a switch 105. When the switch 103 is turned on, a capacitor 104 is charged. A cross voltage of the capacitor 104 is a cross voltage between a gate and a source of the switch 105. When the cross voltage of the capacitor 104 is higher than a threshold voltage of the switch 105, the switch 105 is turned on and a current corresponding to the cross voltage is generated so that an OLED 106 is turned on to emit light. When the switch 103 is turned off, the cross voltage provided by the capacitor 104 is kept unchanged. Thus, the switch 105 is still kept on so that the OLED 106 is still kept on.

The conventional design mentioned hereinabove restricts the structure of the organic diode pixel circuit to the same pattern. However, the display structure of the organic diode pixel still cannot satisfy various requirements in different circuit designs, which are needed to obtain the better electrical effect in the manufacturing processes thereof.

### SUMMARY OF THE INVENTION

The invention is directed to an organic light emitting diode (OLED) pixel circuit using two transistors and one capacitor to drive and control a pixel.

According to a first aspect of the present invention, an OLED pixel circuit is provided. The OLED pixel circuit includes a first switch, a second switch, a capacitor and an OLED. The first switch has its first terminal connected to a first node, its second terminal for receiving a data signal, and its control terminal for receiving a scan signal. The second switch has its first terminal connected to a second node, its second terminal connected to a third node, and its control terminal connected to the first node. The capacitor is connected between the first node and the second node. The OLED includes an anode connected to a fourth node, and a cathode connected to the second node.

According to a second aspect of the present invention, another OLED pixel circuit is provided. The OLED pixel circuit includes a first switch, a second switch, a capacitor and an OLED. The first switch has its first terminal connected to a first node, its second terminal for receiving a data signal, and its control terminal for receiving a scan signal. The second switch has its first terminal connected to a second node, its second terminal connected to a third node, and its control terminal connected to the first node. The capacitor is connected between the first node and a fourth node. The OLED includes an anode connected to the fourth node and a cathode connected to the second node.

According to a third aspect of the present invention, still another OLED pixel circuit is provided. The OLED pixel circuit includes a first switch, a second switch, a capacitor and an OLED. The first switch has its first terminal connected to a first node, its second terminal for receiving a data signal, and its control terminal for receiving a scan signal. The second switch has its first terminal connected to a second node, its second terminal connected to a third node, and its control terminal connected to the first node. The capacitor is connected between the first node and the third node. The OLED includes an anode connected to the third node, and a cathode connected to a fourth node.

According to a fourth aspect of the present invention, yet still another OLED pixel circuit is provided. The OLED pixel circuit includes a first switch, a second switch, a capacitor and an OLED. The first switch has its first terminal connected to a first node, its second terminal for receiving a data signal, and its control terminal for receiving a scan signal. The second switch has its first terminal connected to a second node, its second terminal connected to a third node, and its control terminal connected to the first node. The capacitor is connected between the first node and a fourth node. The OLED includes an anode connected to the third node, and a cathode connected to the fourth node.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a circuit diagram showing a pixel circuit according to the prior art.

FIG. 2A is a circuit diagram showing an OLED pixel circuit according to a first embodiment of the invention.

FIG. 2B is another circuit diagram showing the OLED pixel circuit according to the first embodiment of the invention.

FIG. 3A is a circuit diagram showing an OLED pixel circuit according to a second embodiment of the invention.

FIG. 3B is another circuit diagram showing the OLED pixel circuit according to the second embodiment of the invention.

FIG. 4A is a circuit diagram showing an OLED pixel circuit according to a third embodiment of the invention.

FIG. 4B is another circuit diagram showing the OLED pixel circuit according to the third embodiment of the invention.

FIG. 5A is a circuit diagram showing an OLED pixel circuit according to a fourth embodiment of the invention.

FIG. 5B is another circuit diagram showing the OLED pixel circuit according to the fourth embodiment of the invention.

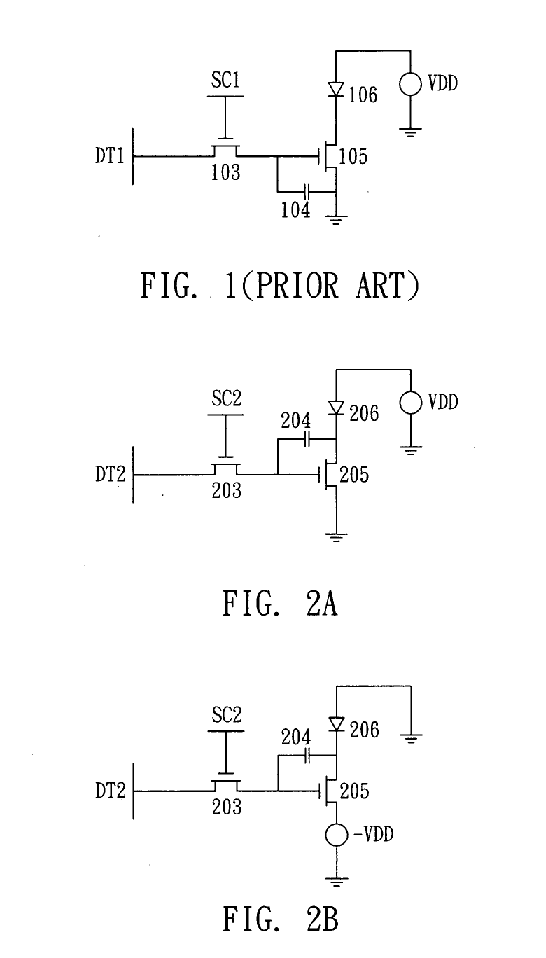

### DETAILED DESCRIPTION OF THE INVENTION

The invention provides four OLED pixel circuits, each of which uses two transistor switches and one capacitor to control a luminance of an OLED pixel so as to provide various arrangements of elements in the organic pixel circuit.

FIG. 2A is a circuit diagram showing an OLED pixel circuit according to a first embodiment of the invention. Referring to FIG. 2A, the device circuit of the pixel circuit includes a first switch 203, a second switch 205, a capacitor 204 and an OLED 206. Each of the first switch 203 and the second switch 205 illustrated in the example of FIG. 2A is an N-type metal oxide semiconductor (NMOS) transistor, and may be various transistors in practice.

Referring to FIG. 2A, the first switch 203 includes a first terminal (drain), a second terminal (source) and a control terminal (gate), and the second switch 205 includes a first terminal (drain), a second terminal (source) and a control terminal (gate). The OLED 206 includes an anode and a cathode. The second terminal of the first switch 203 receives a data signal DT2, and the control terminal of the first switch 203 receives a scan signal SC2. The first terminal of the second switch 205 is coupled to the cathode of the OLED 206, the second terminal of the second switch 205 is grounded, and the control terminal of the second switch 205 is coupled to the first terminal of the first switch 203. The capacitor 204 is connected between the control terminal and the first terminal of the second switch 205. The anode of the OLED 206 is coupled to a positive voltage source VDD. The first switch 203 controls whether to transmit the data signal DT2 to the second switch 205. When the first switch 203 is turned on, the capacitor 204 is charged to enable the capacitor 204 to generate a cross voltage, such that a cross voltage is generated between the gate and the source of the second switch 205. When the cross voltage between the gate and the source of the second switch 205 is higher than a threshold voltage of the second switch 205, the second switch 205 is turned on and generates a drain current corresponding to the cross voltage so that the OLED 206 is turned on to emit light. When the first switch 203 is turned off, the cross voltage provided by the capacitor 204 is kept unchanged. So, the cross voltage between the gate and the source of the second switch 205 is also kept unchanged, the second switch 205 is still kept on, and the same drain current is kept so that the OLED 206 is still kept on.

In the illustrated example of FIG. 2A, the anode of the OLED 206 is coupled to the positive voltage source VDD, and the second terminal of the second switch 205 is grounded. In practice, however, the anode of the OLED 206 may also be grounded, and the second terminal of the second switch 205 may be coupled to a negative voltage source −VDD. FIG. 2B is another circuit diagram showing the OLED pixel circuit according to the first embodiment of the invention. As shown in the device circuit diagram of the pixel circuit in FIG. 2B, the anode of the OLED 206 is grounded, and the second terminal of the second switch 205 is coupled to a negative voltage. The other circuit connections and operation principles of FIG. 2B are the same as those of FIG. 2A, so detailed descriptions thereof will be omitted.

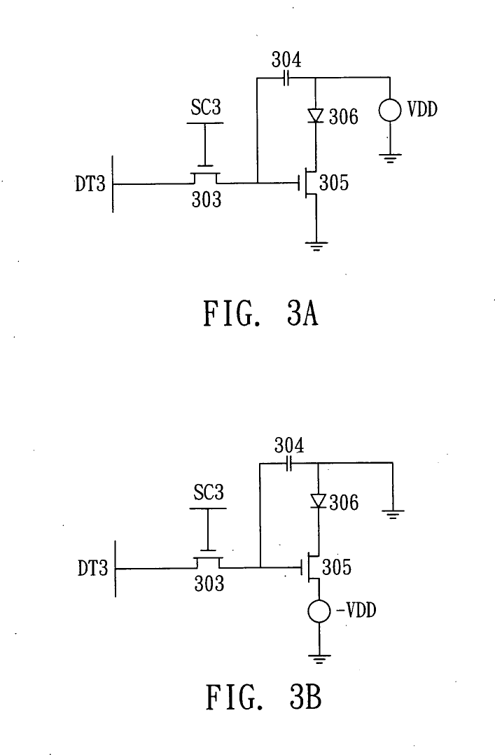

FIG. 3A is a circuit diagram showing an OLED pixel circuit according to a second embodiment of the invention. As shown FIG. 3A, the device circuit of the pixel circuit includes a first switch 303, a second switch 305, a capacitor 304 and an OLED 306. Each of the first switch 303 and the second switch 305 illustrated in FIG. 3A is an N-type metal oxide semiconductor (NMOS) transistor, and may be various transistors in practice.

Referring to FIG. 3A, the first switch 303 includes a first terminal (drain), a second terminal (source) and a control terminal (gate), and the second switch 305 includes a first terminal (drain), a second terminal (source) and a control terminal (gate). The OLED 306 includes an anode and a cathode. The second terminal of the first switch 303 receives a data signal DT3, and the control terminal of the first switch 303 receives a scan signal SC3. The first terminal of the second switch 305 is coupled to the cathode of the OLED 306, the second terminal of the second switch 305 is grounded, and the control terminal of the second switch 305 is coupled to the first terminal of the first switch 303. The capacitor 304 is connected between the control terminal of the second switch and the anode of the OLED. The anode of the OLED 306 is coupled to a positive voltage source VDD.

The first switch 303 controls whether to transmit the data signal DT3 to the second switch 305. When the first switch 303 is turned on, the capacitor 304 is charged to make the capacitor 304 generate a cross voltage. The cross voltage of the capacitor 304 makes a cross voltage be generated between the gate and the source of the second switch 305. When the cross voltage between the gate and the source of the second switch 305 is higher than a threshold voltage of the second switch 305, the second switch 305 is turned on and generates a drain current corresponding to the cross voltage so that the OLED 306 is turned on to emit light. When the first switch 303 is turned off, the cross voltage provided by the capacitor 304 is kept unchanged. So, the cross voltage between the gate and the source of the second switch 305 is also kept unchanged, the second switch 305 is still kept on, and the same drain current is kept so that the OLED 306 is still kept on.

In the illustrated example of FIG. 3A, the anode of the OLED 306 is coupled to the positive voltage source VDD, and the second terminal of the second switch 305 is grounded. In practice, however, the anode of the OLED 306 may also be grounded, and the second terminal of the second switch 305 may be coupled to a negative voltage source −VDD. FIG. 3B is another circuit diagram showing the OLED pixel circuit according to the second embodiment of the invention. As shown in the device circuit diagram of the pixel circuit in FIG. 3B, the anode of the OLED 306 is grounded, and the second terminal of the second switch 305 is coupled to a negative voltage. The other circuit connections and operation principles of FIG. 3B are the same as those of FIG. 3A, so detailed descriptions thereof will be omitted.

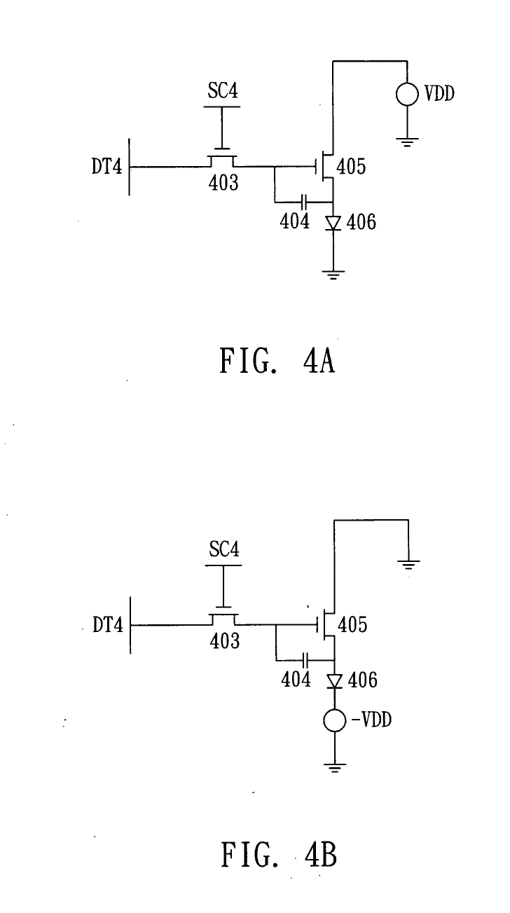

FIG. 4A is a circuit diagram showing an OLED pixel circuit according to a third embodiment of the invention. Referring to FIG. 4A, the device circuit of this pixel circuit includes a first switch 403, a second switch 405, a capacitor 404 and an OLED 406. Each of the first switch 403 and the second switch 405 illustrated in FIG. 4A is an N-type metal oxide semiconductor (NMOS) transistor, and may be various transistors in practice.

Referring to FIG. 4A, the first switch 403 includes a first terminal (drain), a second terminal (source) and a control terminal (gate), and the second switch 405 includes a first terminal (drain), a second terminal (source) and a control terminal (gate). The OLED 406 includes an anode and a cathode. The second terminal of the first switch 403 receives a data signal DT4, and the control terminal of the first switch 403 receives a scan signal SC4. The first terminal of the second switch 405 is coupled to a positive voltage source VDD, the second terminal of the second switch 405 is coupled to the anode of the OLED 406, and the control terminal of the second switch 405 is coupled to the first terminal of the first switch 403. The capacitor 404 is connected between the control terminal and the second terminal of the second switch. The cathode of the OLED 406 is grounded.

The first switch 403 controls whether to transmit the data signal DT4 to the second switch 405. When the first switch 403 is turned on, the capacitor 404 is charged to make the capacitor 404 generate a cross voltage, such that a cross voltage be generated between the gate and the source of the second switch 405. When the cross voltage between the gate and the source of the second switch 405 is higher than a threshold voltage of the second switch 405, the second switch 405 is turned on and generates a drain current corresponding to the cross voltage so that the OLED 406 is turned on to emit light. When the first switch 403 is turned off, the cross voltage provided by the capacitor 404 is kept unchanged. So, the cross voltage between the gate and the source of the second switch 405 is also kept unchanged, the second switch 405 is still kept on, and the same drain current is kept so that the OLED 406 is still kept on.

In the illustrated example of FIG. 4A, the first terminal of the second switch 405 is coupled to the positive voltage source VDD, and the cathode of the OLED 406 is grounded. In practice, however, the first terminal of the second switch 405 may be grounded and the cathode of the OLED 406 may be coupled to the negative voltage source −VDD. FIG. 4B is another circuit diagram showing the OLED pixel circuit according to the third embodiment of the invention. As shown in the device circuit diagram of the pixel circuit in FIG. 4B, the cathode of the OLED 406 is coupled to a negative voltage, and the first terminal of the second switch 405 is grounded. The other circuit connections and operation principles of FIG. 4B are the same as those of FIG. 4A, so detailed descriptions thereof will be omitted.

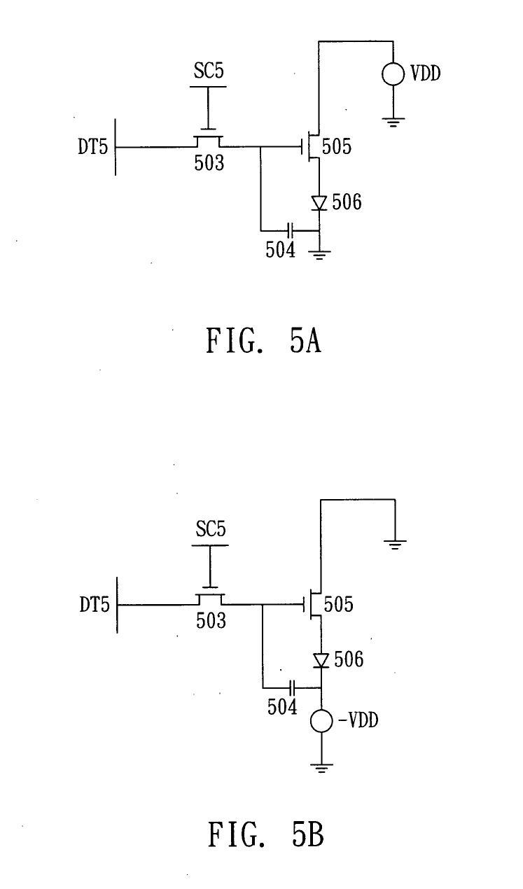

FIG. 5A is a circuit diagram showing an OLED pixel circuit according to a fourth embodiment of the invention. Referring to FIG. 5A, the device circuit of the pixel circuit includes a first switch 503, a second switch 505, a capacitor 504 and an OLED 506. Each of the first switch 503 and the second switch 505 illustrated in FIG. 5A is an N-type metal oxide semiconductor (NMOS) transistor, and may be various transistors in practice.

Referring to FIG. 5A, the first switch 503 includes a first terminal (drain), a second terminal (source) and a control terminal (gate), and the second switch 505 includes a first terminal (drain), a second terminal (source) and a control terminal (gate). The OLED 506 includes an anode and a cathode. The second terminal of the first switch 503 receives a data signal DT5, and the control terminal of the first switch 503 receives a scan signal SC5. The first terminal of the second switch 505 is coupled to a positive voltage source VDD, the second terminal of the second switch 505 is coupled to the anode of the OLED 506, and the control terminal of the second switch 505 is coupled to the first terminal of the first switch 503. The capacitor 504 is connected between the control terminal of the second switch and the cathode of the OLED. The cathode of the OLED 506 is grounded.

The first switch 503 controls whether to transmit the data signal DT5 to the second switch 505. When the first switch 503 is turned on, the capacitor 504 is charged to generate a cross voltage, such that a cross voltage is generated between the gate and the source of the second switch 505. When the cross voltage between the gate and the source of the second switch 505 is higher than a threshold voltage of the second switch 505, the second switch 505 is turned on and generates a drain current corresponding to the cross voltage so that OLED 506 is turned on to emit light. When the first switch 503 is turned off, the cross voltage provided by the capacitor 504 is kept unchanged. So, the cross voltage between the gate and the source of the second switch 505 is also kept unchanged, the second switch 505 is still kept on, and the same drain current is kept so that the OLED 506 is still kept on.

In the illustrated example of FIG. 5A, the first terminal of the second switch 505 is coupled to the positive voltage source VDD, and the cathode of the OLED 506 is grounded. In practice, the cathode of the OLED 506 is coupled to a negative voltage source −VDD, and the first terminal of the second switch 505 is grounded.

FIG. 5B is another circuit diagram showing the OLED pixel circuit according to the fourth embodiment of the invention. In the device circuit diagram of the pixel circuit, the cathode of the OLED 506 is coupled to a negative voltage, and the first terminal of the second switch 505 is grounded. The other circuit connections and operation principles of FIG. 5B are the same as those of FIG. 5A, so detailed descriptions thereof will be omitted.

In each of the circuits of four different OLED pixel circuits, two transistor switches and one capacitor are used to control the luminance of one OLED pixel. When the scan signal is enabled, a current corresponding to the data signal flows through a diode to control the luminance of the pixel.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An organic light emitting diode (OLED) pixel circuit for receiving a data signal and a scan signal, the OLED pixel circuit comprising:
a first switch, having its first terminal connected to a first node, its second terminal for receiving the data signal, and its control terminal for receiving the scan signal;
a second switch, having its first terminal connected to a second node, its second terminal connected to a third node, and its control terminal connected to the first node;
an energy storage element connected between the first node and the second node; and
an OLED, which comprises an anode connected to a fourth node, and a cathode connected to the second node.

2. The OLED pixel circuit according to claim 1, wherein each of the first switch and the second switch is an N-type metal oxide semiconductor (NMOS) transistor.

3. The OLED pixel circuit according to claim 2, wherein the fourth node is coupled to a positive voltage and the third node is grounded.

4. The OLED pixel circuit according to claim 3, wherein when the scan signal is enabled, the first switch is turned on and a current is generated to enable the energy storage element to generate a cross voltage so that a cross voltage capable of turning on the second switch is generated between the control terminal and the second terminal of the second switch; a current flowing through the OLED is generated to enable the OLED emit light after the second switch turns on; when the scan signal is disabled, the first switch is turned off, the cross voltage between the control terminal and the second terminal of the second switch is kept unchanged so that the second switch is still kept on and the OLED is still kept on.

5. The OLED pixel circuit according to claim 2, wherein the fourth node is grounded and the third node is coupled to a negative voltage.

6. The OLED pixel circuit according to claim 5, wherein when the scan signal is enabled, the first switch is turned on and a current is generated to enable the energy storage element generate a cross voltage so that a cross voltage capable of turning on the second switch is generated between the control terminal and the second terminal of the second switch; after the second switch is turned on, a current flowing through the OLED is generated to enable the OLED emit light; when the scan signal is disabled, the first switch is turned off the cross voltage between the control terminal and the second terminal of the second switch is kept unchanged so that the second switch is still kept on and the OLED is still kept on.

7. An organic light emitting diode (OLED) pixel circuit for receiving a data signal and a scan signal, the OLED pixel circuit comprising:
a first switch, having its first terminal connected to a first node, its second terminal for receiving the data signal, and its control terminal for receiving the scan signal;
a second switch, having its first terminal connected to a second node, its second terminal connected to a third node, and its control terminal connected to the first node;
an energy storage element connected between the first node and a fourth node; and
an OLED, which comprises an anode connected to the fourth node and a cathode connected to the second node.

8. The OLED pixel circuit according to claim 7, wherein each of the first switch and the second switch is an N-type metal oxide semiconductor (NMOS) transistor.

9. The OLED pixel circuit according to claim 8, wherein the fourth node is coupled to a positive voltage and the third node is grounded.

10. The OLED pixel circuit according to claim 9, wherein when the scan signal is enabled, the first switch is turned on and a current is generated to enable the energy storage element to generate a cross voltage so that a cross voltage capable of turning on the second switch is generated between the control terminal and the second terminal of the second switch; a current flowing through the OLED is generated to enable the OLED to emit light after the second switch turns on; when the scan signal is disabled, the first switch is turned off, the cross voltage between the control terminal and the second terminal of the second switch is kept unchanged so that the second switch is still kept on and the OLED is still kept on.

11. The OLED pixel circuit according to claim 8, wherein the fourth node is grounded and the third node is coupled to a negative voltage.

12. The OLED pixel circuit according to claim 11, wherein when the scan signal is enabled, the first switch is turned on and a current is generated to enable the energy storage element to generate a cross voltage so that a cross voltage capable of turning on the second switch is generated between the control terminal and the second terminal of the second switch; a current flowing through the OLED is generated to enable the OLED to emit light after the second switch turns on; when the scan signal is disabled, the first switch is turned off, the cross voltage between the control terminal and the second terminal of the second switch is kept unchanged so that the second switch is still kept on and the OLED is still kept on.

13. An organic light emitting diode (OLED) pixel circuit for receiving a data signal and a scan signal, the OLED pixel circuit comprising:
a first switch having its first terminal connected to a first node, its second terminal for receiving the data signal, and its control terminal for receiving the scan signal;
a second switch having its first terminal connected to a second node, its second terminal connected to a third node, and its control terminal connected to the first node;
an energy storage element connected between the first node and the third node; and
an OLED, which comprises an anode connected to the third node, and a cathode connected to a fourth node.

14. The OLED pixel circuit according to claim 13, wherein each of the first switch and the second switch is an N-type metal oxide semiconductor (NMOS) transistor.

15. The OLED pixel circuit according to claim 14, wherein the fourth node is grounded and the second node is coupled to a positive voltage.

16. The OLED pixel circuit according to claim 15, wherein when the scan signal is enabled, the first switch is turned on and a current is generated to enable the energy storage element to generate a cross voltage so that a cross voltage capable of turning on the second switch is generated between the control terminal and the second terminal of the second switch; a current flowing through the OLED is generated to enable the OLED to emit light after the second switch turns on; when the scan signal is disabled, the first switch is turned off but the cross voltage between the control terminal and the second terminal of the second switch is kept unchanged so that the second switch is still kept on and the OLED is still kept on.

17. The OLED pixel circuit according to claim 14, wherein the second node is grounded and the fourth node is coupled to a negative voltage.

18. The OLED pixel circuit according to claim 17, wherein when the scan signal is enabled, the first switch is turned on and a current is generated to enable the energy storage element generate a cross voltage so that a cross voltage capable of turning on the second switch is generated between the control terminal and the second terminal of the second switch; a current flowing through the OLED is generated to enable the OLED to emit light after the second switch turns on; when the scan signal is disabled, the first switch is turned off but the cross voltage between the control terminal and the second terminal of the second switch is kept unchanged so that the second switch is still kept on and the OLED is still kept on.

19. An organic light emitting diode (OLED) pixel circuit for receiving a data signal and a scan signal, the OLED pixel circuit comprising:
a first switch having its first terminal connected to a first node, its second terminal for receiving the data signal, and its control terminal for receiving the scan signal;
a second switch having its first terminal connected to a second node, its second terminal connected to a third node, and its control terminal connected to the first node;
an energy storage element connected between the first node and a fourth node; and
an OLED, which comprises an anode connected to the third node, and a cathode connected to the fourth node.

20. The OLED pixel circuit according to claim 19, wherein each of the first switch and the second switch is an N-type metal oxide semiconductor (NMOS) transistor.

21. The OLED pixel circuit according to claim 20, wherein the fourth node is grounded and the second node is coupled to a positive voltage.

22. The OLED pixel circuit according to claim 21, wherein when the scan signal is enabled, the first switch is turned on and a current is generated to make the energy storage element generate a cross voltage so that a cross voltage capable of turning on the second switch is generated between the control terminal and the second terminal of the second switch; a current flowing through the OLED is generated to enable the OLED to emit light after the second switch turns on; when the scan signal is disabled, the first switch is turned off but the cross voltage between the control terminal and the second terminal of the second switch is kept unchanged so that the second switch is still kept on and the OLED is still kept on.

23. The OLED pixel circuit according to claim 20, wherein the second node is grounded and the fourth node is coupled to a negative voltage.

24. The OLED pixel circuit according to claim 23, wherein when the scan signal is enabled, the first switch is turned on and a current is generated to make the energy storage element generate a cross voltage so that a cross voltage capable of turning on the second switch is generated between the control terminal and the second terminal of the second switch; a current flowing through the OLED is generated to enable the OLED to emit light after the second switch turns on; when the scan signal is disabled, the first switch is turned off but the cross voltage between the control terminal and the second terminal of the second switch is kept unchanged so that the second switch is still kept on and the OLED is still kept on.
